(19) United States
(12) Patent Application Publication
(10) Pub. No.: US 2008/0161736 A1
(43) Pub. Date: Jul. 3, 2008

(54) Massage device of chair type

(76) Inventor: Richard Leifer, Melville, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/646,893

(22) Filed: Dec. 28, 2006

(51) Int. Cl. A61H 37/00

(52) U.S. Cl. 601/134

(57) ABSTRACT

A massage chair having a primary purpose for use as a barber/beautician chair. The chair may include a hydraulic cylinder with a piston for adjusting the height of the chair, a foot rest and a movable neck support. The neck support is movably attached to the back rest and is configured to be moved near the client's neck in a massage position, and away from the neck when desired. The back rest, seat and neck support are configured to include massage units disposed therein to provide therapeutic massage to various parts of the user's body including the back, neck and/or seat and legs when the user is seated in the chair.

### BACKGROUND

1. Field of Technology

The present invention relates to massage devices, and more particularly, it relates to a massage device incorporated in a barber or beautician's chair to support and provide non-obtrusive therapeutic massage of the neck, back and seat areas.

2. Description of Related Art

Many people utilize the services of barbers and beauticians for hair styling, curling, cutting, shampooing, etc. During such procedures, an important consideration is proper positioning of the client to allow the hairstylist to perform the tasks effectively. Indeed, the use of chairs adapted for barber or beautician use is very widespread throughout the hair salon industry. Such chairs are typically vertically adjustable in their distance from the ground and facilitate the work of the hair stylist/hairdresser by positioning the occupant at the desired height during haircutting and styling. Other chairs are adapted for positioning the occupant for shampooing, e.g., by reclining the occupant so that the head is positioned over a sink, or for positioning the client under a hair dryer or hot lamp device.

Many of the procedures (permanent waves, hair coloring) take significant amounts of time to perform, and often entail a client sitting in a chair for hours awaiting completion of the process. During this entire time, the head often must be held erect. Clients are given magazines and other reading material, which are often uncomfortable to read for people with back and neck problems, as the neck must be bent and held at an angle during reading. This is fatiguing and compromises the proper positioning of the spine, which ideally should be straight when sitting.

Accordingly, improving the comfort and ergonomics of a chair user, especially one who is required to sit for long or extended periods of time, would be highly desirable.

### SUMMARY

It is an aspect of the invention to provide a massage device incorporated, e.g., in a barber chair that flexibly provides massage capabilities to not only the seat and back areas, but to a neck area of a seated user in an unobtrusive way which does not interfere with a barber performing hair styling procedures.

It is another aspect of the invention to provide a massage device which may be incorporated into existing structures for providing hands-free therapeutic neck massages of a user.

According to an aspect of the invention a massage device is provided comprising a chair including a seat, a back rest and a base. A neck support is movably attached to the back rest and at least one massage unit disposed in at least one of the seat, back rest and neck support. The neck support is configured to be moved between an in-use position and a not-in-use position.

According to another aspect of the present invention, a massage device is provided comprising a neck support having at least one massage unit disposed therein and a movable arm configured to be attached to the neck support at a first end for enabling movement of the neck support to a desired position.

According to yet another aspect of the present invention, a massage device is provided comprising a chair including a seat, a back rest, a base and a foot rest. A neck support is provided movably attached to the back rest via an arm and at least one massage unit is disposed in each of the seat, back rest and neck support. The neck support is configured to be moved between an in-use position and a not-in-use position.

Other aspects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a side view of an exemplary massage chair according to an embodiment of the present invention;

FIG. 2 is a front view of the exemplary massage chair of FIG. 1 according to an embodiment of the present invention;

FIG. 3 a side view of an exemplary massage chair according to an embodiment of the present invention;

FIG. 4 is a front view of the exemplary massage chair of FIG. 3 according to an embodiment of the present invention;

FIG. 5 is a side view of an exemplary massage chair with a neck support in a down position according to an aspect of the present invention;

FIG. 6 is a perspective view of a massage chair with a neck support in a removed position according to an aspect of the present invention; and

FIG. 7 is a sectional view showing massage units incorporated into an exemplary chair according to an aspect of the present invention.

### DETAILED DESCRIPTION

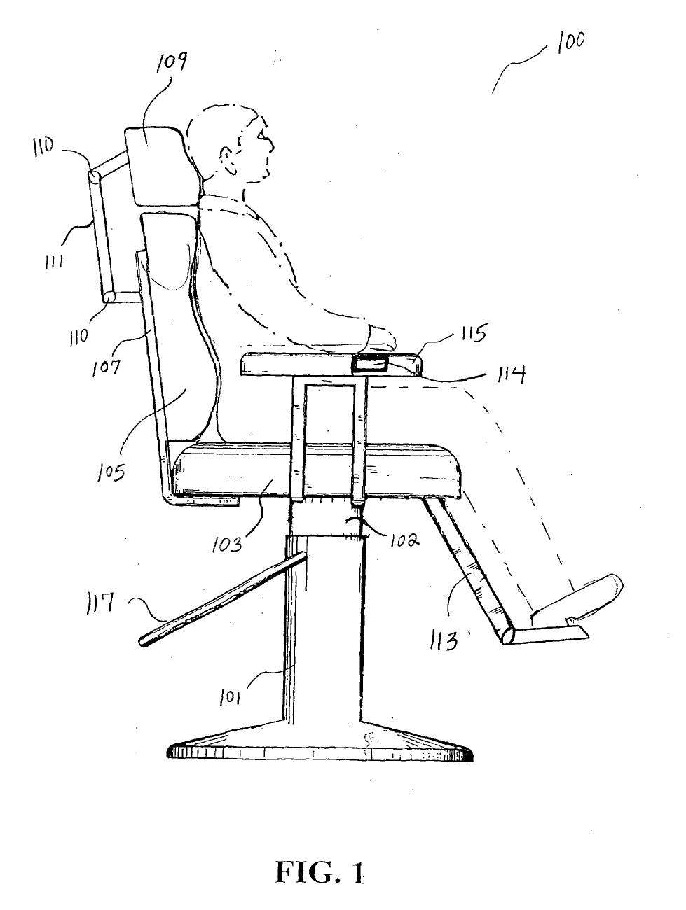

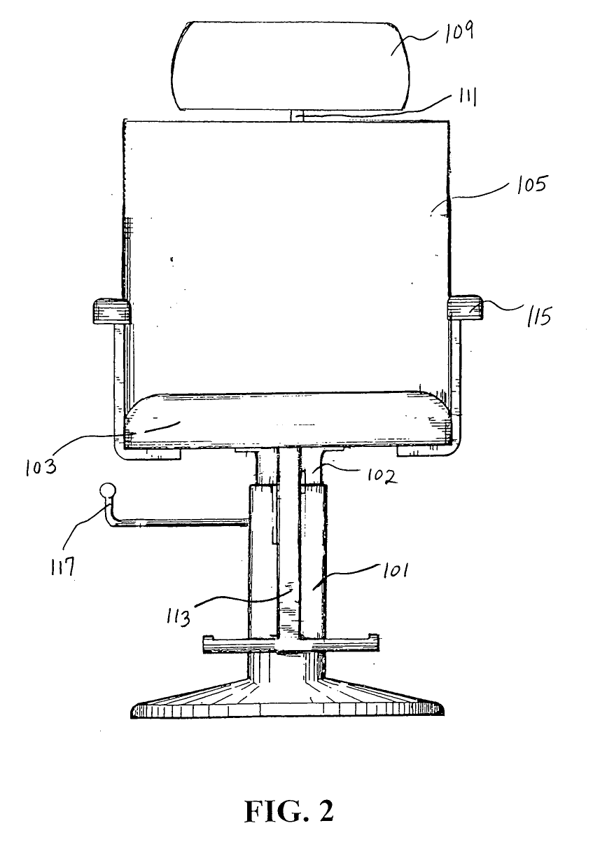

FIGS. 1-7 show various views of an exemplary massage chair according to the present invention. Preferably, a massage chair according to the present invention incorporates massage capabilities into a chair adapted for barber chair use. For example, as shown, there is a massage barber chair 100 comprising a base 101 to which a seat 103 is horizontally affixed at a top end thereof. For example, the base 101 may include a hydraulic cylinder with a piston 102 which is raised or lowered by the handle or lever 117 to operate the piston for adjusting the height of the client for the convenience of the barber/hair stylist during hair styling procedures. Other means for raising and lowering the chair to a desired height may be contemplated.

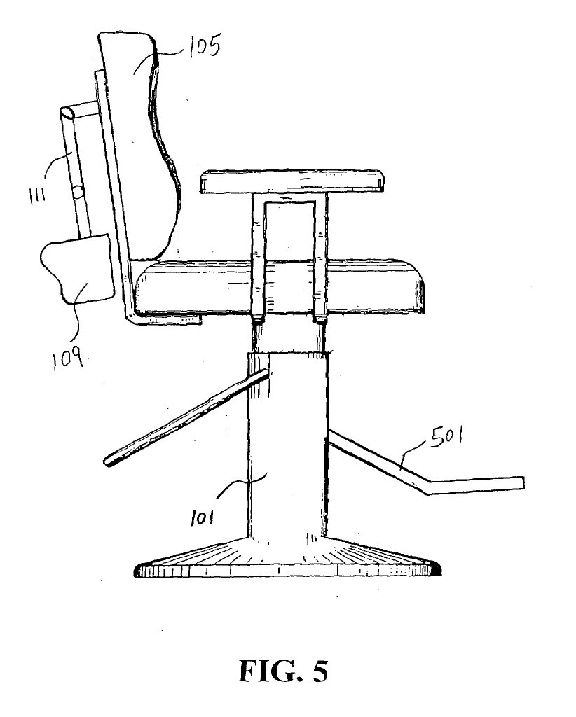

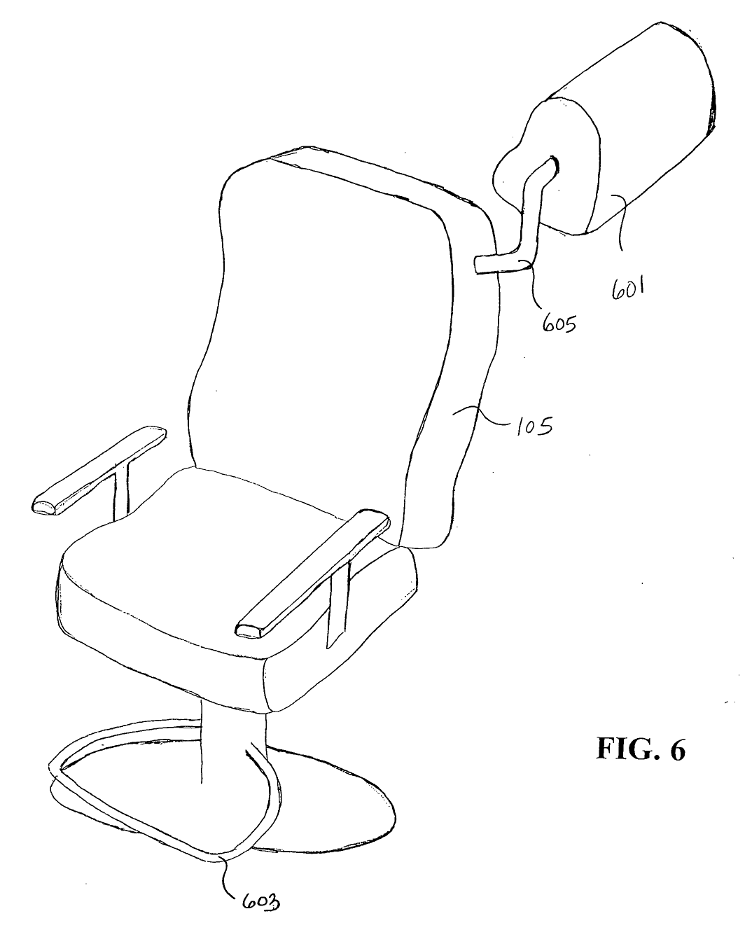

The chair includes a back rest 105, a pair of arm rests 115 and a foot rest 113. A rod 107 connects the back rest 105 to the seat 103, and may be adapted to attach the back rest 105 to the seat 103 at a fixed angle and/or be configured to enable tilting/reclining of the back rest 105. For example, rod 107 may include springs, flex rods and/or be comprised of resilient material adapted to give to pressure but spring back into its original position upon release of such pressure. The back rest 105 is preferably ergonomically configured, including at least a lumbar support, and is shaped to support the spine of a seated occupant in an ergonomically correct position. The seat 103 may also be ergonomically designed. The foot rest 113 is preferably configured to be adjustable in a vertical and/or horizontal direction for the comfort of the client. The foot rest 113 may be connected to, e.g., the bottom of seat 103, as shown in FIG. 1, or alternatively, e.g., to the base 101, as illustrated by foot rest 501 in FIG. 5 and foot rest 603 in FIG. 6.

A neck massager support 109 is provided movably attached via a rear arm 111 to a rear side of the back rest 105. The rear arm 111 may include pivotable and/or rotatable joints 110 for permitting the neck support 109 to be moved from an in-use position (e.g., located above a top side of the back rest 105 and adjacent to, in contact with or near a seated client's neck) for providing support and/or massage, to a ‘removed’ or not-in-use position (e.g., away from the top side of the back rest/away from the client's neck) when the neck support is not in use for support or massage. For example, FIG. 5 shows neck support 109 in an exemplary ‘removed’ position (here, e.g., retracted flat against the rear side of the back rest 105).

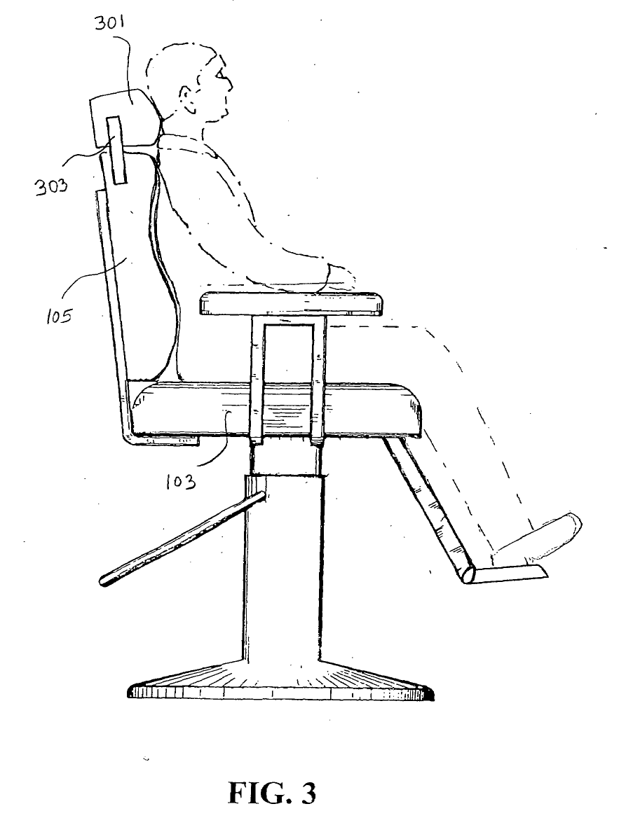

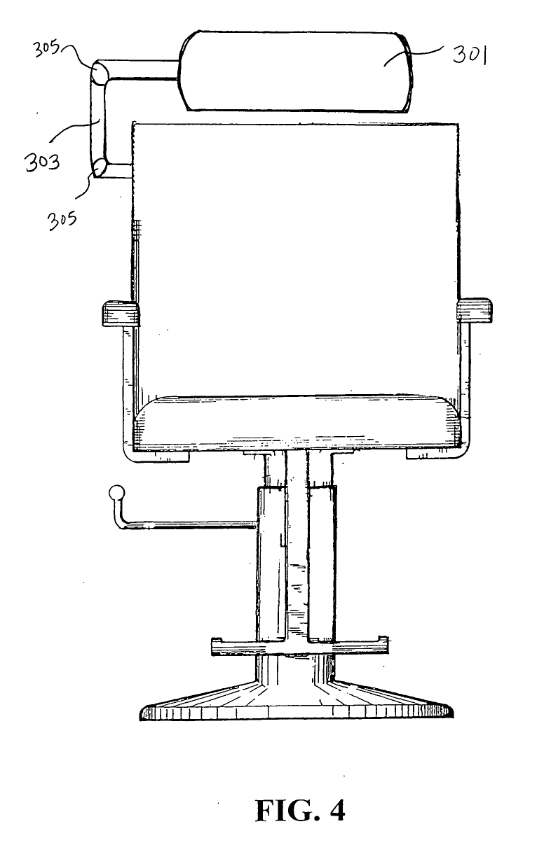

In another embodiment, a neck support 301 may be provided movably attached to either a left or right side portion of the back rest 105, as shown in FIG. 3, via a side arm 303. The side arm 303 may include joints 305 (see FIG. 4) for permitting pivoting/rotation of the neck support 301. Note that side arm 303 may be attached to the neck support 301 at a side, rear or top wall thereof; FIG. 3 illustrates attachment of the side arm 303 to a side wall of the neck rest 301 and to a right side of the back rest 105 for illustrative purposes.

Each arm 111, 303 may include at least two pivotable/rotatable joints 110, 305 to facilitate a full range of motion, e.g., at predetermined increments or to an infinite number of positions. Once a desired position is achieved, such attained position may be locked into place. Alternatively, arms 111, 303 and/or 605 may be comprised of a unitary flexible, formable material that may be shaped/bent in any desired direction to facilitate placement of the neck support in various positions.

According to an aspect of the present invention, the neck supports 109, 301 may be moved to a multitude or infinite number of positions between an in-use position (e.g., as shown in FIG. 1) and a not-in-use position (e.g., as shown in FIG. 5). When a desired position is achieved, the position of the neck support may be locked into place (e.g., via pins, clamps, pressure pegs, etc.) to prevent undesired/unintentional displacement from the desired position. The movable configuration of the neck support according to the present invention allows the support to be positioned closer or farther from the client's neck as desired, to, e.g., increase or minimize contact. The neck supports 109, 301 may be adjusted at least in both horizontal and vertical directions for height adjustment, etc.

The neck supports 109, 301 may be comprised of a cushioning material that is preferably comfortable, supportive and conforming to the neck and head area (e.g., orthopedic foam, memory foam material) and is, in part preferably shaped to fit at least into the recess of a person's neck for providing maximum contact and support in that area. Alternate shapes may be contemplated, e.g., the neck support may be configured to wrap around a wider area of the user's neck and/or head for a wider area of support and massage.

FIG. 6 illustrates positioning of a neck support 601 away from a top side of the back rest of the chair via movable arm 605 according to one embodiment of the present invention. Here, the neck support 601 is connected to a left side of the back rest 105.

Advantageously, the mobility of a neck support according to the present invention enables the barber to remove the neck support from the neck area of the chair occupant to have unimpeded access to the rear of the client's head during, e.g., hair styling procedures. Alternatively, if a client must wait for a period of time unattended (e.g., during a hair coloring procedure, before the stylist can attend to the client, or when a particular a hair styling procedure is completed) the neck massager/support 109, 301 may be moved back into position behind the client's neck so that the client may enjoy the benefits of cervical neck support and therapeutic massage during waiting, as explained further below.

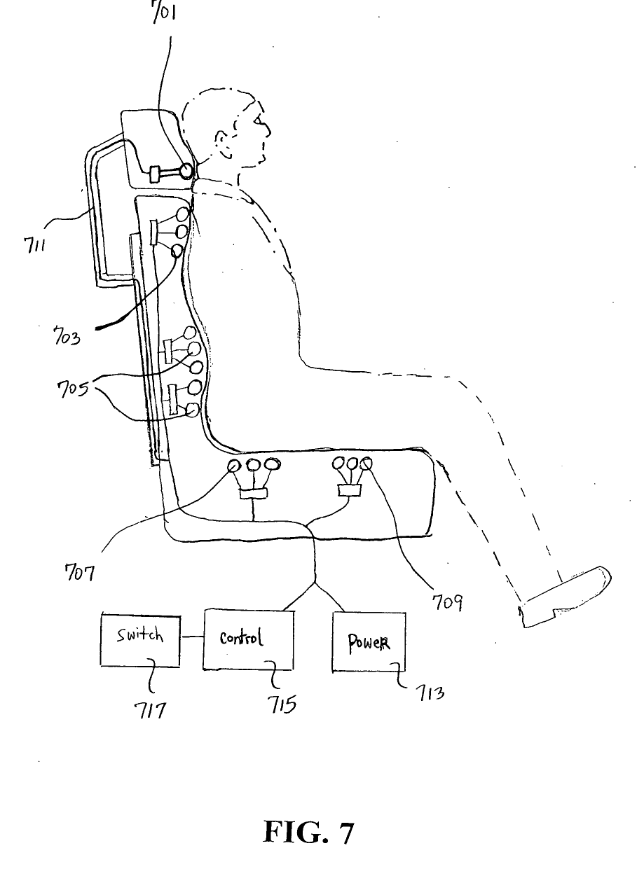

According to an aspect of the present invention, any or all of the seat 103, back rest 105 and neck support 109 are configured to provide therapeutic massage capability. For example, as shown in FIG. 7, a plurality of massage units 701, 703, 705, 707 and 709 are provided for providing hands-free massage to neck, upper back, lower back, buttocks and hamstrings of a user, respectively. More or less massage units may be provided in different locations of the chair to massage different muscle groups or areas as desired. Massage units may comprise, e.g., ball-shaped or other rounded implements which deliver the massaging effects to the seated user through the cushion/fabric of the chair. The massage units are connected to power source 713 and control 715 which may be adapted to direct the massage units to provide e.g., percussive, rolling, kneading, vibration, tapping, etc. movements and other massage techniques. A switch 717 is provided to operate the massage units and may be embodied in, e.g., a control panel 114 removably/permanently affixed on the chair, and/or a remote control unit. Note that a connecting wire 711 may connect the massage units 701 through the arm 111 and rod 107 to the power supply 713, control 715, etc.

The chair of FIG. 7 may comprise, e.g., a barber chair (e.g., as shown in FIG. 1). Massage units may be incorporated into any of the heretofore discussed neck support configurations (e.g., neck support 109 or 301).

The ergonomic shape of the neck supports 109, 301 and their adjustability provide customized massage for the user. For example, a neck support according to the present invention may be pushed firmly up against the back of the neck for maximum contact and a more forceful massage. The height of the neck support may be adjusted via the arms 111, 303 to fit the user's dimensions.

In another embodiment, a neck support including a massaging unit according to the present invention may be retrofit to existing chairs, sofas or other structures via, e.g., an attachment kit, to provide removable neck support/massage capabilities at any chair or location. Such attachment kit may include, e.g., a movable arm configured to be attached at a first end to the neck support and at a second end to, e.g., a chair. Attachment means may comprise, e.g., clamps, clips, bolts, etc.

While there have been shown, described and pointed out fundamental novel features of the present principles as applied to preferred embodiments thereof, it will be understood that various omissions, substitutions and changes in the form and details of the methods described and devices illustrated, and in their operation, may be made by those skilled in the art without departing from the spirit of the present principles. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or embodiment of the present principles may be incorporated in any other disclosed, described or suggested form or embodiment as a general matter of design choice. It is the intention, therefore, to be limited only as indicated by the scope of the claims appended hereto.

What is claimed is:

1. A barber/beautician chair comprising:
a chair having a primary purpose as a barber/beautician chair; and
at least one massage unit integrated into the chair.

2. The barber/beautician chair of claim 1, wherein said chair further comprises:
a neck support connected to the chair; and
at least one massage unit disposed in the neck support.

3. The barber/beautician chair of claim 1, further comprising means for raising and lowering the chair.

4. A barber/beautician chair comprising:
a chair having a primary purpose as a barber/beautician chair;
means for raising and lowering the chair; and
at least one massage unit integrated into the chair.

5. The barber/beautician chair of claim 1, further comprising:
a neck support connected to the chair; and
at least one massage unit disposed in the neck support.

6. A barber chair comprising:
a chair including a seat, a back rest and a base;
a neck support movably attached to the back rest;
at least one massage unit disposed in at least one of the seat, back rest and neck support, the neck support configured to be moved between an in-use position and a not-in-use position.

7. The chair of claim 6, further including an arm for movably attaching the neck support to the back rest.

8. The chair of claim 6, wherein the base includes a hydraulic cylinder for adjusting the height of the seat.

9. The chair of claim 6, wherein the seat is connected to the back rest via a resilient rod.

10. The chair of claim 6, wherein the in-use position comprises the neck support being positioned above the top of the back rest for contacting a seated user's neck area.

11. The chair of claim 6, wherein the not-in-use position comprises the neck support being positioned away from a seated user's neck area.

12. The chair of claim 6, further including a remote control for controlling the at least one massage unit.

13. The chair of claim 6, further including an adjustable foot rest attached to the chair.

14. The chair of claim 7, wherein the arm attaches the neck support to a rear side of the back rest, said arm being configured to lock the neck support in a desired position.

15. The chair of claim 7, wherein the arm attaches the neck support to a left or right side portion of the back rest, said arm being configured to lock the neck support in a desired position.

16. A massage device comprising:
a neck support having at least one massage unit disposed therein;
a movable arm configured to be attached to the neck support at a first end for enabling movement of the neck support to a desired position.

17. The device of claim 16, further including attachment means for attaching a second end of the arm to a back rest of a chair.

18. The device of claim 16, wherein the arm includes at least two joints that are at least one of pivotable or rotatable.

19. A barber chair comprising:
a chair including a seat, a back rest, a base and a foot rest;
a neck support movably attached to the back rest;
at least one massage unit disposed in each of the seat, back rest and neck support.

20. The chair of claim 19, wherein the base includes a hydraulic cylinder for adjusting the height of the seat.

21. The chair of claim 19, wherein the in-use position comprises the neck support being positioned above the top of the back rest.

22. The chair of claim 19, wherein the not-in-use position comprises the neck support being positioned away from the top of the neck support.

23. The chair of claim 19, wherein said neck support further is movable attached to the back rest via an arm, said arm enabling said neck support to be moved between an in-use position and a not-in-use position.

24. The chair of claim 23, wherein the arm attaches the neck support to a rear side of the back rest, said arm being configured to lock the neck support in a desired position.

25. The chair of claim 23, wherein the arm attaches the neck support to a left or right side portion of the back rest, said arm being configured to lock the neck support in a desired position.
